(19) United States
(12) Patent Application Publication
(10) Pub. No.: US 2005/0236387 A1
(43) Pub. Date: Oct. 27, 2005

(54) Food preparation and cooking system

(76) Inventor: Edward E. Stockley, Plano, TX (US)

Correspondence Address: FISH & RICHARDSON P.C., 1717 MAIN STREET, SUITE 5000, DALLAS, TX, 75201, US

(21) Appl. No.: 11/103,723

(22) Filed: Apr. 12, 2005

Related U.S. Application Data
(60) Provisional application No. 60/561,639, filed on Apr. 13, 2004.

(51) Int. Cl. A21B 1/00

(52) U.S. Cl. 219/394

(57) ABSTRACT

A compact scalable food preparation center (10) is adapted for the preparation of custom ordered pizzas on a walk-in or drive-through basis. The center has a base unit (12) with a food preparation surface (14), a refrigerated storage unit (16) under the food preparation surface, and a refrigerated topping storage area (18) on the food preparation surface, the topping storage area having a cover (19). An oven (20) is positioned on top of the base unit with a solid cooking surface and heating elements spaced above the solid cooking surface. The oven is controlled to cook non-frozen raw pizzas with toppings in less than 4 minutes.

This application claims the benefit of U.S. Provisional Application No. 60/561,639, filed Apr. 13, 2004.

### TECHNICAL FIELD

This invention relates to food preparation centers, and more particularly to food preparation centers including refrigerated storage and an oven.

### BACKGROUND

It is desirable to cook foods quickly while also obtaining a proper texture in the foods after cooking. Standard ovens and brick ovens tend to give the proper texture but take longer than desired. Microwave ovens are known for fast cooking, but bread dough and other foods do not achieve proper texture when cooked in a microwave. Convection ovens may achieve the proper texture for some foods and are quicker than standard ovens, but are not fast enough for walk-up service as in a convenience store or fast food restaurant.

As an example, there are no commercial ovens known that can cook a raw pizza of standard size from a raw state to a properly browned and crisp state in less than four minutes.

Additionally, it is desirable to have a compact preparation center that allows for the refrigerated storage for all necessary components of a food product as well as the means to prepare and cook the food products in a timely fashion.

### SUMMARY

A compact scalable food preparation center is adapted for the preparation of custom ordered pizzas on a walk-in or drive-through basis. The center has a base unit with a food preparation surface, a refrigerated storage unit under the food preparation surface, and a refrigerated topping storage area on the food preparation surface, the topping storage area having a cover. One or more ovens, which may be similar to the oven described by U.S. patent application Ser. No. 11/029,754 is positioned on top of the base unit with a solid cooking surface and heating elements spaced above the solid cooking surface. The oven is controlled to cook non-frozen raw pizzas and partially cooked pizzas with toppings.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a front view of a food preparation center.

FIG. 2 is a top view of the food preparation center of FIG. 1.

FIG. 3 is a side view of the food preparation center of FIG. 1.

FIG. 4 is a perspective view of an alternative food preparation center.

Like reference symbols in the various drawings indicate like elements.

### DETAILED DESCRIPTION

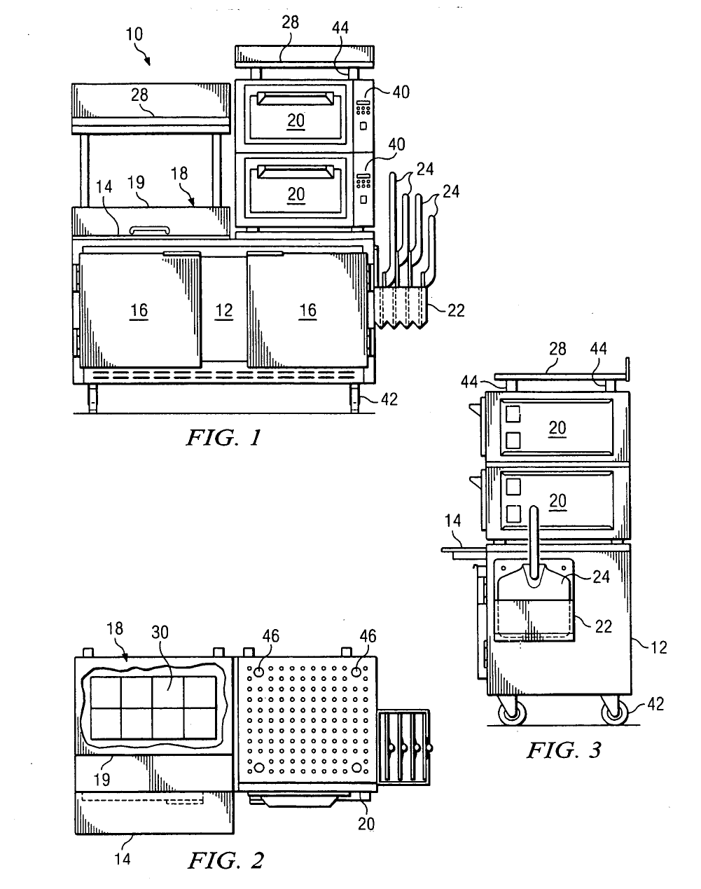

As shown in FIGS. 1, 2 and 3, a food preparation center 10 includes a base unit 12 with a food preparation surface 14 and a storage area 16 that may be refrigerated. A topping storage area 18 may be recessed into the food preparation surface 14. The topping storage area 18 may also be refrigerated, non-refrigerated, and/or covered by a topping storage cover 19. An oven 20 is positioned on top of the base unit 12. Peel storage 22 is attached to the side of base unit 12, and peels 24 are stored in peel storage 22. As shown in FIGS. 1, 3 and 4, two ovens may be included in the food preparation center 10. Multiple ovens may be configured in a stacked or side-by-side configuration, or any other suitable configuration. Topping storage cover 19 may be connected to the food preparation surface 14 by hinges or simply placed over the topping storage area 18 to reduce or prevent contamination and/or reduce the amount of cooling necessary to maintain the refrigeration of the contents of the topping storage area 18.

An implementation of one type of oven 20 is described in more detail in U.S. patent application Ser. No. 11/029,754, with the title “Air Control for a Brick Oven,” as well as U.S. Pat. No. 6,114,663, U.S. Pat. No. 6,355,914, and U.S. patent application Ser. No. 10/077,250, all incorporated herein by reference. As such, the illustrated oven 20 has a solid cooking surface, upper heating element, lower heating element, fan, and a control unit. The “solid” cooking surface may include a surface that has a substantially non-apertured surface, a hollow portion with a substantially planar surface, a partially apertured surface, or other suitable surface. In a preferred implementation, the solid cooking surface includes a smooth, substantially un-apertured surface, such as a baking stone. The oven 20 described in the above patents is capable of cooking a raw pizza with toppings in less than four minutes with a crispy crust and browned cheese. An additional oven 20 may be provided above the first oven, as shown in FIGS. 1 and 3. It should be understood that other types of ovens may be substituted for the oven 20 described above, such as a conventional oven, microwave oven, conveyor oven, or other suitable types of ovens.

The food preparation center 10 provides a station for preparing and cooking custom food products, such as pizza, calzones, stromboli, and other food products, in a timely manner for walk-up or drive-through service. Additionally, the food preparation center 10 may be located in a restaurant, department store, convenience store, outdoor or indoor kiosk, or other suitable location.

As shown in FIGS. 1 and 3, the peel storage 22 may be on the side of the food preparation center 10. A peel 24 may be employed by an operator/cook to provide a movable surface upon which to prepare a pizza or other food item to be cooked in the oven 20. The peel 24 may also be used to insert and remove the food item into and from, respectively, one of the ovens 20. The peel 24 may be removed from the peel storage 22 and placed on the food preparation surface 14. A raw pizza crust or other food item may then be removed from the refrigerated storage 16 in the base unit 12.

In the case of a pizza crust, sauce and cheese may already be pre-applied to the crust, or the cheese, sauce, and/or other toppings may be stored in the refrigerated storage unit 16 or in another storage area, such as the topping storage area 18. The pizza crust may be placed on the peel 24, on the food preparation surface 14, or directly in one of the ovens 20. If additional toppings are desired, toppings may be chosen from the topping storage area 18 and placed on the pizza crust to form a pizza tailored to a customer's order. The peel 24 may then used to place the raw pizza into one of the ovens 20.

A cooking code may be entered into a control unit 40 on the front of an oven 20 into which the raw pizza is placed. Various codes may be used for different types of foodstuffs. The cooking codes may correspond to the relative amount of cooking applied to pizzas and/or other types of food items, such as sandwiches, calzones, and other types of foods. The cooking codes may also determine the ratio of heat between multiple cooking elements in the convection oven(s) as well as the amount of convection applied within the oven while cooking a food item. The cooking codes, which may be entered into the control unit 40 by a user, may be a programmed cooking sequence resident in the control unit 40, and correspond to cooking programs that allow pizzas to be fully cooked in less than four minutes, or allow rapid cooking of other types of raw foodstuffs. In most cases the pizza will be completely assembled and cooked in less than four minutes as the oven may require as little as two and a half minutes to cook a raw pizza.

Shelves 28 may be provided for storage of non-refrigerated items, such as pizza boxes or spices. Alternatively, additional ovens 20 may be added above or below the ovens 20 shown in FIGS. 1 and 3. Additional ovens may also be attached to either side of the food preparation center 10 to increase the cooking capacity.

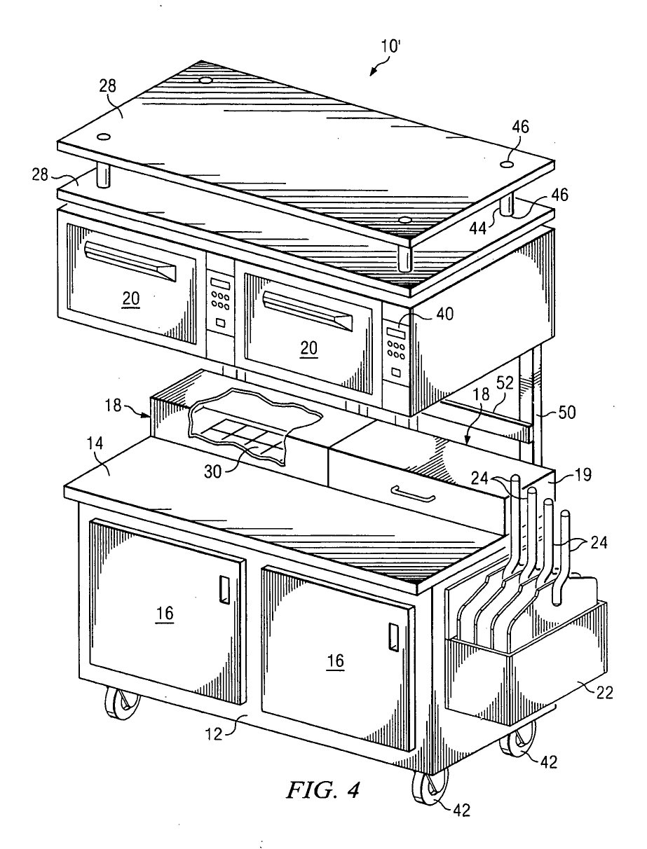

FIG. 4 shows an alternative configuration for a food preparation center 10. The food preparation center 10′ includes many similar features as the food preparation center 10 depicted in FIGS. 1-3. The food preparation center 10′ includes ovens 20 in a side-by-side configuration. Such a configuration may allow for a larger food preparation surface 14. Additionally, four or more ovens 20 (not shown) may be placed in a food preparation center 10′ such that the ovens 20 are stacked both vertically and horizontally in the food preparation center 10′. The food preparation center 10′ may include two topping storage areas 18, each having a topping storage area cover 19. Alternatively, the food preparation center 10′ may include only one topping storage area 18 such that the food preparation surface 14 is larger. Such a configuration may be advantageous if the food preparation center is manufactured as a cabinet-depth system which affords a smaller depth from the front of the preparation center to the rear of the preparation center.

Similar to the food preparation center 10 illustrated in FIGS. 1-3, the food preparation center 10′ includes at least one base unit 12 with a food preparation surface 14 and a refrigerated storage 16. Also, the topping storage area(s) 18 may be recessed into the food preparation surface 14. One or more of the topping storage areas 18 may also be refrigerated, non-refrigerated, and/or covered by a topping storage cover 19. An oven 20 is positioned on top of the base unit 12. Peel storage 22 is attached to the side of base unit 12, and peels 24 are stored in peel storage 22. In certain implementations, the doors and covers, such as the doors for the ovens 20, the refrigerated storage 16, and or the covers for the topping storage areas 18 may be manufactured out of suitable materials, such as metals, plastics, wood, glass, or any combination of thereof. It may be desirable, in various implementations, to have glass, plastic, composite, or other suitable transparent or semi-transparent materials incorporated into barriers of the food preparation centers 10 and/or 10′ such as the doors and lids. Such transparent or semi-transparent materials may allow viewing of the contents behind the barriers, such as a cooking pizza or the contents of a refrigerated area(s) of the food preparation center.

As illustrated in FIGS. 1 and 3, wheels 42 may be attached to the bottom of the food preparation center 10 to facilitate movement of the food preparation center 10 from one location to another. In various implementations, the food preparation center 10 may be used by street vendors, concessionaires, or other food providers that require the transportation of the food preparation center 10. Accordingly, the wheels 42 may allow a user to load or unload the food preparation center 10 onto trucks, planes, or other suitable vessels. The wheels 42 may be traditional wheels, castors, rollers, or other suitable apparatus for facilitating the rolling of the food preparation center 10 from one location to another.

As best illustrated in FIGS. 1-3, a shelf or shelves 28 may be attached via shelf supports 44. In the implementation shown, the shelf supports 44 are shown as posts. In addition to posts, cylinders, a welded post, or blocks may be used as shelf supports 44. The shelf supports may be securely attached to the underside or “bottom” of the shelf 28 by inserting the shelf supports 44 into indentations located on the bottom of the shelf 28. Alternatively, the shelf supports 44 may be permanently or semi-permanently attached to the bottom of the shelf 28. Permanent or semi-permanent attachment of the shelf supports 44 to the shelf 28 may be accomplished by welding, gluing, bolting, riveting, or other suitable method of attachment.

The shelf supports 44 may also be insertable into indentations 46 on the top of the food preparation center 10. The indentations 46 may be a pre-sized indentation corresponding to the diameter or shape of a shelf support 44, or may be a general indentation that resists, but does not prevent, the removal of the shelf supports 44 when a force is applied thereto. Although the Figures illustrate the indentations 46 on the top surface of the oven 20 (which may be a heat shield), other implementations may include indentions or receivers at other suitable locations. For example, the indentations may be on the top surface of a permanently attached shelf 28, on the food preparation surface 14, or other suitable location. Additionally, the shelf supports 44 may be any suitable length for attaching a shelf to the food preparation center at a desired height.

A number of embodiments of the invention have been described. Nevertheless, it will be understood that various modifications may be made without departing from the spirit and scope of the invention. For example, conveyor ovens, conventional ovens, microwave ovens, toaster ovens, or other types of ovens may be substituted for the convection oven 20. Accordingly, other embodiments are within the scope of the following claims.

1. A scalable food preparation center adapted for the preparation of food, the center comprising:
a base unit having a food preparation surface, at least one refrigerated storage unit, and at least one topping storage area on the food preparation surface;
at least one oven positioned over the base unit, each of the at least one oven having a solid cooking surface and a heating element spaced over the solid cooking surface, the oven controlled to cook food.

2. The food preparation center of claim 1, wherein the at least one topping storage area is refrigerated.

3. The food preparation center of claim 1, wherein the at least one topping storage area comprises a plurality of topping storage areas, each of the plurality of topping storage areas having a cover.

4. The food preparation center of claim 1, wherein the at least one topping storage area is attached to the food preparation surface

5. The food preparation center of claim 1, wherein the at least one topping storage area comprises a recessed area in the food preparation surface.

6. The food preparation center of claim 3, wherein each topping storage area cover comprises a transparent portion, the transparent portion adapted to allow inspection of the contents of the topping storage area without removing the topping storage area cover.

7. The food preparation center of claim 1, wherein the at least one oven comprises a first oven and a second oven.

8. The food preparation center of claim 1, wherein the at least one oven comprises at least two ovens, the at least two ovens being positioned adjacent to each other.

9. The food preparation center of claim 1 wherein:
the oven further comprises a lower heating element below, and spaced apart from, the solid cooking surface, the lower heating element controlled to maintain the solid cooking surface at a temperature adequate to produce a crisp pastry food.

10. The food preparation center of claim 1 wherein each of the at least one oven is a convection oven.

11. The food preparation center of claim 1, further comprising a storage shelf, wherein the storage shelf is adapted to be coupled to the food preparation center by shelf supports.

12. The food preparation center of claim 11, wherein the shelf supports include posts adapted to be inserted in an indentation of at least one top surface of the food preparation center and an indentation of at least one bottom surface of the storage shelf.

13. The food preparation center of claim 7, further comprising a plurality of wheels, the wheels adapted to facilitate the movement of the food preparation center by the rotation of the wheels.

14. A method for preparing a pizza, the method comprising the steps of:
storing pizza ingredients in a refrigerated storage unit;
storing pizza toppings in at least one storage area, wherein the storage area is proximate to a food preparation area;
removing a portion of pizza dough from the refrigerated storage unit;
selecting toppings from the refrigerated bins and adding the selected toppings to the portion of raw pizza dough;
placing the portion of pizza dough with toppings onto a solid cooking surface in a convection oven;
programmably controlling the oven to fully cook the portion in less than 4 minutes;
removing the fully cooked portion from the solid cocking surface of the convection oven with a peel.

15. The method of claim 14, wherein the portion of pizza dough comprises a portion of raw pizza dough.

16. The method of claim 14, wherein the portion of pizza dough includes at least one topping of the group including cheese and sauce.

17. The method of claim 14 further comprising the step of:
preheating the solid cooking surface in the convection oven to a preset temperature range.

18. The method of claim 14, wherein the refrigerated storage area includes a removable cover.

19. The method of claim 18, wherein the removable cover is at least partially transparent.

20. The method of claim 14, wherein the refrigerated storage area comprises a recess in the food preparation surface.

21. The method of claim 14, wherein the oven is a convection oven, the step of programmably controlling including controlling a convection flow and at least one heating element.

22. A scalable food preparation system adapted for the preparation of food, the system comprising:
a base unit having a food preparation surface, at least one refrigerated storage unit, and at least one topping storage area recessed into the food preparation surface, each of the at least one topping storage areas having a cover;
at least one convection oven positioned above the food preparation surface, each of the at least one convection ovens having a solid cooking surface and a heating element spaced above the solid cooking surface, the oven controlled to cook a portion of raw pizza dough.

23. The food preparation center of claim 22, wherein the at least one convection oven comprises a first convection oven and a second convection oven, and wherein the first and second convection ovens are adjacent to each other.

24. The food preparation center of claim 22, wherein the convection oven is adapted to cook the raw portion of pizza dough in less than about 4 minutes.
